(19) United States
(12) Patent Application Publication
(10) Pub. No.: US 2026/0040418 A1
(43) Pub. Date: Feb. 5, 2026

(54) LED LIGHTING CIRCUIT AND LED LUMINAIRE COMPRISING THE SAME

(71) Applicant: SIGNIFY HOLDING B.V., EINDHOVEN (NL)

(72) Inventors: CHUAN LIANG, JIANG SU (CN); LIHUA LIN, SHANGHAI (CN); WEIHUA MIAO, SHANGHAI (CN)

(21) Appl. No.: 19/099,844

(22) PCT Filed: Jul. 18, 2023
(86) PCT No.: PCT/EP2023/069944

§ 371 Date: Jan. 30, 2025

(30) Foreign Application Priority Data
Aug. 2, 2022 (WO) PCT/CN2022/109796
Sep. 26, 2022 (EP) 22197614.5

(51) Int. Cl. H05B 45/46; H05B 45/18

(52) U.S. Cl. CPC H05B 45/46; H05B 45/18

(57) ABSTRACT

A LED lighting circuit comprising: an LED arrangement comprising a first LED string (D1, . . . D72) with a first tap (20) between two LEDs in the first LED string (D1, . . . D72) and a second LED string (D73, . . . D144) with a second tap (22) between two LEDs in the second string (D73, . . . D144), the first and second LED strings connected in parallel,: a power supply arrangement (23) adapted to receive an input power and to provide an output power to the LED arrangement; a bidirectional conduction arrangement (24) connected between the first tap (20) and the second tap (22), said bidirectional conduction arrangement (24) is adapted to be triggered to be conductive when a voltage potential difference between the first tap (20) and the second tap (22) exceeds a threshold, wherein a current conducted by the bidirectional conduction arrangement (24) is adapted to generate a fault signal at a first detection output (240); and a control circuit (27) connected to the first detection output (240) and adapted to control the power supply arrangement (23) to decrease the output power when receiving said fault signal.

### FIELD OF THE INVENTION

The present invention relates to the field of LED lighting circuits, especially to fault protection in LED lighting circuits.

### BACKGROUND OF THE INVENTION

In some high power and compact light engines, LEDs as many as several hundred are used to provide a high lighting power. In order to prevent the output voltage/LED voltage from being extremely high (satisfying safety regulation), the LEDs are divided into multiple strings connected in parallel, and a large current is provided to drive them. The LED strings are designed/binned nonminimally identical, thus the strings will almost evenly share the current. Here nonminimally identical means the string's nominal current, forward voltage and impedance etc. are nearly identical. Of course, this includes the tolerance of each LED chip. In some applications, the driving current of each LED string is very close to the maximum current limit that an LED string can safely work with. If one LED in one LED string fails as an open connection, the related string stops working. The current that would flow through this string will be distributed among the other strings, and may go beyond the maximum current limit of the other strings and damage the other strings, causing the entire light engine to fail. The risk of a fault such as an open circuit is increasing due to wire bond cracks and solder pad cracks, because of the high temperature and stress in high power applications.

FIG. 1 shows an example: the total current from the driver is 5.2 A, and the LEDs are divided into 4 nominally identical strings 1 to 4, with an average distribution of 1.3 A per string and 1.3 A through each LED. The maximum current limit for each LED is 1.5 A. If for example LED D71 of the LEDs is damaged (open circuit), the string 1 where the damaged LED D71 is located cannot allow any current to flow and the total current of that string will be distributed by the other 3 strings 2, 3 and 4, that is, each of the other 3 strings will be assigned 1.73 A current, which exceeds the maximum current limit 1.5 A that the LED string can withstand. This will result in that the other 3 strings of LEDs will also fail quickly. US20080157689A1 discloses using a bidirectional element to be triggered by an open circuit LED and bypassing the LED. The current is routed to another LED in other string. The problem in this prior art is that the other LED has to withstand its original current in its own string as well as the current bypassed from the failed LED in a different string, thus it may receive an overcurrent and fail also.

There are known methods for LED failure detection. For example, the current of each string is sampled by a sensing resistor in that string and compared with a threshold value via a comparator. If the current is less than the threshold, that string can be deemed as an open failure and a signal indicative of this event will be generated and sent to the driver which decreases the output current accordingly. However, these known methods inevitably face problems such as affecting efficiency and power supply difficulties. Even further, the LED board side is often isolated from the driver's controller, and thus this signal obtained at the LED board side also needs to be level shifted to the driver's controller via an isolator.

EP2161969A2 discloses a series connection of multiple LED strings, wherein each LED string is connected in parallel with a bypass circuit that senses a fault in that string.

EP2390672A2 discloses a bidirectional opto-coupler.

DE102004032456B3 discloses parallel connected LED circuits, each of which comprises a boost converter and a LED string.

EP2763503A2 and WO2004068909A1 discloses parallel connected LED strings.

### SUMMARY OF THE INVENTION

The invention is defined by the claims.

A basic idea of the invention is putting a bidirectional conduction arrangement across the parallel LED strings to sense the change in the potential across the strings and generate a fault signal if this change is sensed, and the fault signal is sent to a control circuit to decrease power provide to the strings.

A first aspect of the invention provides a LED lighting circuit comprising: an LED arrangement comprising a first LED string, with a first tap between two LEDs in the first LED string, and a second LED string, with a second tap between two LEDs in the second string (D73, . . . , D144), the first and second LED strings connected in parallel; a power supply arrangement adapted to receive an input power and to provide an output power to the LED arrangement; a bidirectional conduction arrangement connected between the first tap and the second tap and adapted to be triggered to be conductive when a voltage potential difference between the first tap and the second tap exceeds a threshold, wherein a current conducted by the bidirectional conduction arrangement is adapted to generate a fault signal at a first detection output; and a control circuit connected to the first detection output and adapted to control the power supply arrangement to decrease the output power when receiving said fault signal.

A combination of the bidirectional conduction arrangement and the control circuit provides a low-cost, low power loss and effective fault protection. For single fault protection when two parallel LED strings are used, (reasonably assuming that only a single LED string, instead of two or more strings, would fail), one bidirectional conduction arrangement can monitor both LED strings thus there is no need to provide respective monitoring circuits for each LED string. The bidirectional conduction arrangement is not triggered thus does not have power loss in normal operation of the LED lighting circuit when the LED strings are intact. The fault signal is generated directly from the current conducted by the bidirectional conduction arrangement and sent to the control circuit and this does not need a separate comparator as in the known method thus the cost is relatively low. Last but not least, the control circuit actively decreases the output power such that the remaining LED string is still operating without being overpowered and the LED lighting circuit is kept operating reliably.

In a further embodiment, the bidirectional conduction arrangement comprises a current limiting component to limit a current in the bidirectional conduction arrangement to be less than 50 mA.

Since the bidirectional conduction arrangement needs to maintain the fault signal in case of a failure, the bidirectional conduction arrangement also needs to be protected from failure. This embodiment uses the current limiting current to prevent overcurrent in the bidirectional conduction arrangement, and it increases the reliability of the bidirectional conduction arrangement.

In a further embodiment, the bidirectional conduction arrangement comprises an optocoupler with a light emitting side connected between the first tap and the second tap and adapted to emit light when the potential between the first tap and the second tap exceeds the threshold, and a light receiving side connected to the control circuit as the first detection output and adapted to generate the fault signal when receiving light emitted by the light emitting side.

An optocoupler is a low-cost component which is capable of both being triggered by a voltage difference as well as providing level-shifting/isolation. Besides, optocouplers have long working life to continuously maintain the fault signal. The power consumption of an optocoupler is also very low such that the power loss in fault protection is also low.

In a further embodiment, in order to emit light from bidirectional signals, the lighting emitting side comprises a pair of LEDs connected anti-parallel; or a rectifying circuit and one LED. Bidirectional optocoupler with integrated anti-parallel LEDs is a mature off-shelf product and ready to be used. Alternatively, a rectifying circuit and one LED can be used too.

In one low-cost embodiment, the current limiting component comprises a resistor. The resistance of the resistor may be several hundreds Ohms.

In one embodiment, the first LED string and a second LED string are connected in parallel to a same output of the power supply arrangement and are nominally identical, and the first and second taps are at the same relative position in each respective string.

In this embodiment, since the LED strings are identical and connected in parallel and the taps are at the same position, the voltage potential across the two taps would be substantially zero if both LED strings are intact, otherwise the potential would be different and can be detected by the bidirectional conduction arrangement.

In an alternative embodiment, the LED strings can be driven at different outputs of the power supply arrangement. For example, a first current regulation circuit powers the first LED string while a second current regulation circuit powers the second LED string. In this case, the potential across the two LED strings may be different at the first instance when both strings are intact, the bidirectional conduction arrangement can be designed to tolerate and being not responsive to this difference; and the potential would also significantly change when one string is open, and the bidirectional conduction arrangement can be designed to detect/responsive this significant change and send the fault signal. For example, the potential across two taps may be 3V when both strings are intact and it is not enough to make the bidirectional conduction element conductive; the potential increases to 9V when one string is open and it makes the bidirectional conduction element conductive.

In a further embodiment, the first and second tap are near ends of the strings. Putting the taps, as well as the bidirectional conduction arrangement near the end of the LED string makes board layout of the circuit easier. The taps, as well as the bidirectional conduction arrangement can also be put at the middle of the string.

In a further embodiment, the taps and the bidirectional conduction arrangement are at a distance of at least two LEDs from the ends of the strings. In this embodiment, if one LED string is open, the potential between the taps in the LED strings is the forward voltage of the at least two LEDs and thus is sufficient to activate the optocoupler.

In an embodiment, the LED lighting circuit further comprises a temperature detection arrangement adapted to detect a temperature associated with said LED arrangement and to generate a temperature signal at a second detection output if the temperature exceeds a temperature limit, and the control circuit is further connected to the second detection output and adapted to control the power supply arrangement to decrease the output power based on the temperature signal, wherein the first detection output and the second detection output are connected together and to the control circuit.

In this embodiment, the LED lighting circuit also comprises a thermal protection, and the open circuit protection and the thermal protection use a single interface to send a protection signal to the control circuit. This embodiment has an advantage of low cost since only one single interface is used for both the fault signal of open circuit and the temperature signal of over temperature.

In a further embodiment, said temperature detection arrangement comprises a temperature dependent resistor thermally coupled with the LED arrangement, an optocoupler with a light emitting side and a light receiving side connected to the control circuit as the second detection output, and a powering circuit adapted to power the light emitting side of said optocoupler, wherein said temperature dependent resistor is adapted to deactivate, or reduce the output power of, the powering circuit when the temperature exceeds the temperature limit.

This embodiment provides a low-cost implementation for the temperature detection arrangement based on a temperature dependent resistor, such as an NTC (negative temperature coefficient) or a PTC (positive temperature coefficient) resistor thermally coupled with the LED arrangement. For example, the temperature dependent resistor and the LED arrangement are placed close by on the same PCB such that the temperature dependent resistor can detect the temperature of the LED arrangement reliably.

In a further embodiment, the LED lighting circuit comprises a duplicate of the LED arrangement and the bidirectional conduction arrangement connected with each other, and the first detection outputs of the two bidirectional conduction arrangements are connected together and to the control circuit.

In this embodiment, four or more LED strings can be divided to different pairs and each pair has a bidirectional conduction arrangement to detect an open circuit in one LED string in that pair. Since the solution is low-cost and needs only a few components, it is quite easy to scale up the number of LED strings according to practical needs and provide fault detection and protection for these LED strings.

Additionally, the fault signals from the bidirectional conduction arrangements are adapted to be superimposed and the power supply arrangement is adapted to decrease the output power according to the superimposed fault signals.

In this embodiment, the superimposed fault signals are indicative of how many pairs of the LED strings fail, and the power supply arrangement can decrease the output power accordingly. For example, in a two-pair configuration, if the superimposed fault signal indicates only one string in one pair fails, the control circuit can control the power supply arrangement to decrease the output power to 75%; and if the superimpose fault signal indicates that both pairs have a respective failed string, the control circuit can control the power supply arrangement to decrease the output power to 50%. This embodiment intelligently adjusts the output power to match the remaining LED strings and keeps them working in nominal working condition, avoiding either overpowering or underpowering the remaining LED strings.

In a second aspect of the invention, it is provided a LED luminaire comprising the LED lighting circuit according to the above aspect and embodiments.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a fault occurring in a LED lighting circuit without fault detection and protection;

FIG. 2 illustrates a LED lighting circuit with fault detection and protection according to embodiments of the present application;

FIG. 3 illustrates an operation of the LED lighting circuit in FIG. 2 when one portion in the first string is open;

FIG. 4 illustrates an operation of the LED lighting circuit in FIG. 2 when another portion in the first string is open;

FIG. 5 illustrates an operation of the LED lighting circuit in FIG. 2 when one portion in the second string is open; and

FIG. 6 illustrates an operation of the LED lighting circuit in FIG. 2 when another one portion in the second string is open.

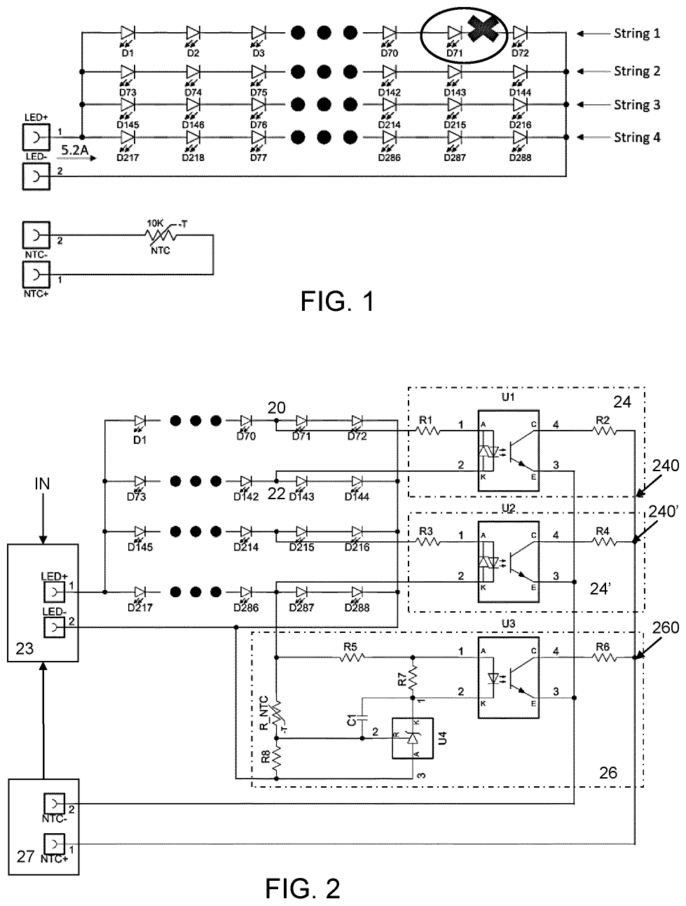

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

As shown in FIG. 2, the LED lighting circuit comprises an LED arrangement comprising a first LED string comprising LEDs D1 to D70, D71, D72 and a second LED string comprising LEDs D73 to D142, D143 and D144. The first LED string comprises a tap 20 and the second LED string comprises a tap 22. The first LED string and the second LED string are coupled in parallel.

A power supply arrangement 23 is adapted to receive an input power IN and to provide an output power to the LED arrangement.

A bidirectional conduction arrangement 24 is connected between the first tap 20 in the first LED string D1 to D72 and the second tap 22 in the second LED string D73 to D144, said bidirectional conduction arrangement 24 is adapted to be triggered to be conductive when a difference in the potential between the first tap 20 and the second tap 22 exceeds a threshold and a current conducted by the bidirectional conduction arrangement 24 is adapted to generate a fault signal at a first detection output 240.

A control circuit 27 connected to the first detection output 240 and adapted to control the power supply arrangement 23 to decrease the output power if receives said fault signal.

The power supply arrangement could be a two-stage power supply comprising a first PFC stage connected with an AC input and generating a bus voltage, and a second current regulation stage to further convert the bus voltage into a desired output current. The current regulation stage usually has a capability of adjusting the output current, and the control circuit 27 could instruct the current regulation stage to decrease the output power/current. The control circuit could be implemented by discrete circuits or by integrated circuits.

Preferably, to limit the current through the bidirectional conduction component in order to reduce power loss and prevent damage, the bidirectional conduction arrangement 24 may comprise a current limiting component to limit a current in the bidirectional conduction arrangement less than 50 mA. In a low-cost embodiment, the current limiting component is a resistor R1 and its resistance of several hundreds Ohms, such as 470 Ohms.

In one example, the bidirectional conduction component comprises an optocoupler U1 with a light emitting side A-K connected between the first tap 20 and the second tap 22 and adapted to emit light when the potential between the first tap 20 and the second tap 22 exceeds the threshold, and a light receiving side C-E connected to the control circuit 27 as the first detection output 240) and adapted to generate the fault signal when receiving light emitted by the light emitting side A-K. In this embodiment, the light emitting side comprises a pair of LEDs connected anti-parallel such that it is responsive to the either a positive or a negative, namely bidirectional, potential difference between the first tap 20 and the second tap 22. In an alternative embodiment, the anti-parallel LEDs can be replaced by a rectifying circuit and one LED.

Preferably, the first LED string D1 to D72 and the second LED string D73 to D144 are connected in parallel and are nominally identical, and the first tap 20 and second tap 22 are at the same relative position in respective string. In this embodiment, each tap is at the anode of the second last LED in each string.

In this embodiment, besides the open circuit protection, the LED lighting circuit also has an overtemperature protection. The LED lighting circuit comprises a temperature detection arrangement 26 adapted to detect a temperature associated with the LED arrangement and to generate a temperature signal at a second detection output 260 if the temperature exceeds a temperature limit, and the control circuit 27 is further connected to the second detection output 260 and adapted to control the power supply arrangement to decrease the output power if receives the temperature signal. In order to minimize the number of the connection with the control circuit, since both the fault signal and the temperature signal are used for triggering protection so as to decrease the output power, the two signals can be mixed, and the first detection output 240 and the second detection output 260 are connected together and to the control circuit. In the circuit in FIG. 2, the first detection output 240 and the second detection output 260 are connected to the NTC+ and NTC− terminal of the control circuit 27.

As to the overtemperature protection, the temperature detection arrangement 26 comprises a temperature dependent resistor R_NTC, an optocoupler U3 with a light emitting side A-K, and a light receiving side C-E connected to the control circuit 27 as the second detection output 260 and a powering circuit R5 adapted to power the light emitting side of said optocoupler U3, wherein said temperature dependent resistor R_NTC is adapted to activate the powering circuit, optionally via a comparing circuit including a TL431 U4, when the temperature exceeds the temperature limit.

More specially, a resistor R8 can set the temperature limit, a capacitor Cl is a negative feedback capacitor, resistors R5, R6 are the current limiting resistors, and the resistor R7 is the power supply for the comparing circuit U4.

The description will first explain the thermal protection, and then explain the open circuit protection which informs the control circuit via the same output used by the thermal protection. When the temperature of the LED board carry the LED arrangement rises, the temperature of the resistor R_NTC rises and the resistance of the resistor R_NTC decreases, and the voltage at the electrode 2 of the comparator U4 rises. When the voltage rises to 2.5V, the comparator U4 closes its electrodes 1 and 3, which makes U3 be powered, and the impedance of the lighting receiving side C-E of the optocoupler U3 decreases, pulling down the voltage at the second detection output 260. The control circuit 27 detects the decreased resistance value of U3_CE+R6 through R6 or detects the decreased voltage on the second detection output 260, and controls the power supply arrangement 23 to decrease the output power/current to prevent further over temperature.

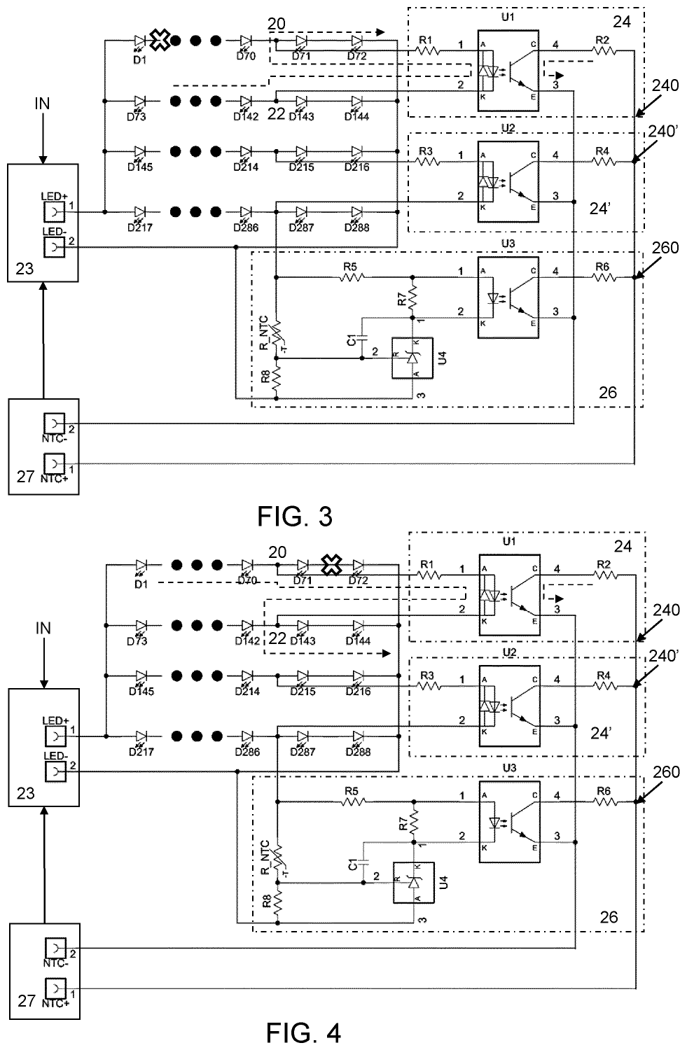

As to the open circuit protection, FIG. 3 shows how the bidirectional conduction arrangement works.

As an example, to start, both the first and the second LED strings are intact as a normal operation state. Assume that the total output current is 5.2 A, and the current through each parallel string is 1.3 A. Because the difference in the forward voltages of the LED D71+D72 in the first LED string and the LEDs D143+D144 in the second LED string is substantially zero or very small, the potential across the first tap 20 and the second tap 22 is almost zero, and the optocoupler U1 cannot work. The bidirectional conduction arrangement does not output a fault signal at the first protection output 240. The control circuit 27 does not receive this fault signal and would not control the power supply arrangement 23 to decrease the output power/current.

In FIG. 3, when any LED of D1-D70 in the first LED string D1-D72 is open as shown by the cross icon, the output voltage of the power supply arrangement is applied on a series connection of the LED D73-D142, the optocoupler U1, the resistor R1, and the LED D71 and D72. In other words, the voltage of LED D143 and D144 is applied across the optocoupler U1, the resistor R1 and the LED D71 and D72. At this time, it would make the optocoupler U1 and the LED D71 and D72 conduct more or less and flow a current, the LEDs D71 and D72 are in a low current conduction, and the voltage difference on the K-A terminal of optocoupler U1 makes U1 work, and the impedance of U1's C-E terminal is reduced. The voltage on the first protection output 240 decreases, and the decreased voltage as the fault signal is sent to the control circuit 27 through R2. The control circuit 27 controls the power supply arrangement 23 to decrease the total output current, from 5.2 A to 3.9 A for example, so that the LED current in LED string 2, 3, and 4 is restored to 1.3 A.

In FIG. 4, when any LED of D71-D72 in the first LED string D1-D72 is open as shown by the cross icon, the output voltage of the power supply arrangement 23 is applied to the LED D1 to D70, the resistor R1, the optocoupler U1 and the LED D142 and D144. At this time, it would make the optocoupler U1 conduct more or less and flow a current, and the voltage difference on the A-K terminal of optocoupler U1 makes U1 work, and the impedance of U1's C-E terminal is reduced. The voltage on the first protection output 240) decreases, and the decreased voltage as the fault signal is sent to the control circuit through R2. The control circuit controls the power supply arrangement 23 to decrease the corresponding total output current to 3.9 A for example, so that the LED current in strings 2. 3, and 4 is restored to 1.3 A.

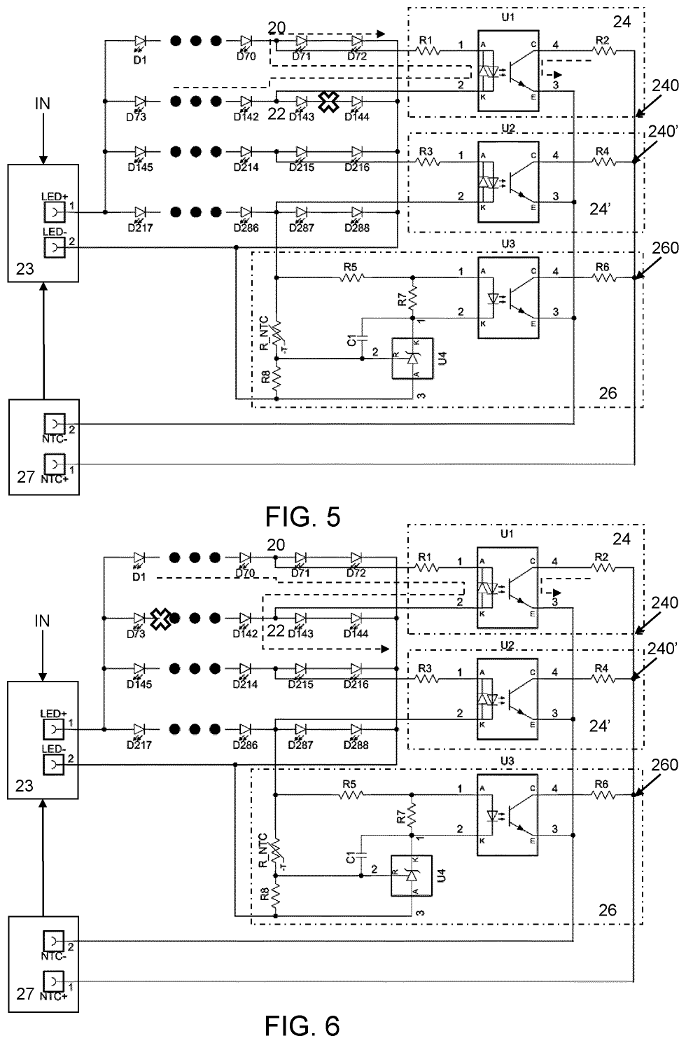

The bidirectional conduction arrangement can also monitor the other string's failure. In FIG. 5, when any LED of D143-D144 in the second LED string D74-D144 is open as shown by the cross icon, the output voltage of the power supply arrangement 23 is applied to the LED D73 to D142, the optocoupler U1, the resistor R1 and the LED D71 and D72. At this time, it would make the optocoupler U1 conduct more or less and flow a current. the voltage difference on the K-A terminal of optocoupler U1 makes U1 work, and the impedance of U1's C-E terminal is reduced. The voltage on the first protection output 240 decreases, and the decreased voltage as the fault signal is sent to the control circuit 27 through the resistor R2. The control circuit 27 controls the power supply arrangement 23 to decrease the total output current to 3.9 A for example, so that the LED current in strings 1, 3, and 4 is restored to 1.3 A.

In FIG. 6, when any LED of D73-D142 in the second LED string D73-D142 is open as shown by the cross icon, the output voltage of the power supply arrangement 23 is applied to the LED D1-D70, the resistor R1, the optocoupler U1 and the LED D143 and D144. In other words, the voltage of LED D71 and D72 is applied across the resistor R1, the optocoupler U1 and the LEDs D143 and D144. At this time, it would make the optocoupler U1 and the LED D143 and D144 conduct more or less and flow a current, the LEDs D143 and D144 are in a low current conduction, and the voltage difference on the A-K terminal of optocoupler U1 makes U1 work, and the impedance of U1's C-E terminal is reduced. The voltage on the first protection output 240 decreases, and the decreased voltage as the fault signal is sent to the control circuit 27 through the resistor R2. The control circuit 27 controls the power supply arrangement 23 to decrease the total output current from 5.2 A to 3.9 A for example, so that the LED current in LED string 1, 3, and 4 is restored to 1.3 A.

A single fault condition is assumed for the parallel strings of LEDs D1 to D72 and LEDs D73 to D144, in other words, the present embodiment can monitor and protect the failure of a single one of the two strings, whereas the case that both strings fail is ignored.

Preferably, the LED lighting circuit comprises a duplicate of the LED arrangement and the bidirectional conduction arrangement. The first LED string of this duplicate is D145 to D216, and the second LED string of this duplicate is D217 to D288. The bidirectional conduction arrangement 24′ is of the duplicate. The operation of the bidirectional conduction arrangement 24′ in monitoring and protecting any one of the two LED strings D145 to D216 and D217 to 288 is similar with the above.

In case that one LED string in D1 to D72 and D73 to D144 and one string in D145 to D216 and D217 to D288 fail, both the bidirectional conduction components 24 and 24′ are triggered and the impedance of C-E terminal of both the optocoupler U1 and U2 become low impedance, the voltage at the detection output 240/240′ is further decreased to a level lower than the level when only one string of the four strings fails. The control circuit 27 can sense this lower level and would control the power supply arrangement 23 to decrease the output power/current to an even lower value, such as 2.6 A, so that the LED current in two remaining LED strings is restored to 1.3 A.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A LED lighting circuit comprising:
an LED arrangement comprising a first LED string, with a first tap between two LEDs in the first LED string, and a second LED string, with a second tap between two LEDs in the second string, the first and second LED strings connected in parallel;
a power supply arrangement adapted to receive an input power and to provide an output power to the LED arrangement;
a bidirectional conduction arrangement connected between the first tap and the second tap and adapted to be triggered to be conductive when
either a voltage potential difference between the first tap and the second tap exceeds a threshold in case that the first LED string and the second LED string are nominally identical and the first and second taps are at the same relative position in respective string, or
a change in a voltage potential across the first LED string and the second LED string is sensed,
wherein the bidirectional conduction arrangement is adapted to generate a fault signal at a first direction output upon a current conducted by the bidirectional conduction arrangement; and
a control circuit connected to the first detection output and adapted to control the power supply arrangement to decrease the output power when receiving said fault signal.

2. The LED lighting circuit according to claim 1, wherein the bidirectional conduction arrangement comprising a current limiting component to limit a current in the bidirectional conduction arrangement less than 50 mA.

3. The LED lighting circuit according to claim 1, wherein the bidirectional conduction arrangement comprises:
an optocoupler with a light emitting side connected between the first tap and the second tap and adapted to emit light when the potential between the first tap and the second tap exceeds the threshold, and a light receiving side connected to the control circuit as the first detection output and adapted to generate the fault signal when receiving light emitted by the light emitting side,
wherein the lighting emitting side comprises:
a pair of LEDs connected anti-parallel; or
a rectifying circuit and one LED.

4. The LED lighting circuit according to claim 2, wherein the current limiting component comprises a resistor.

5. The LED lighting circuit according to claim 1, wherein the first tap and second tap are near ends of the strings.

6. The LED lighting circuit according to claim 5, wherein the first tap and the second tap are near ends of the strings at a distance of at least two LEDs from the ends of the strings.

7. The LED lighting circuit according to claim 1, further comprising:
a temperature detection arrangement adapted to detect a temperature associated with said LED arrangement and to generate a temperature signal at a second detection output if the temperature exceeds a temperature limit, and
the control circuit is further connected to the second detection output and adapted to control the power supply arrangement to decrease the output power when receiving the temperature signal,
wherein the first detection output and the second detection output are connected together and to the control circuit.

8. The LED lighting circuit according to claim 7, wherein said temperature detection arrangement comprises:
a temperature dependent resistor thermally coupled with the LED arrangement,
an optocoupler with a light emitting side and a light receiving side connected to the control circuit as the second detection output, and
a powering circuit adapted to power the light emitting side of said optocoupler,
wherein said temperature dependent resistor is adapted to activate the powering circuit when the temperature exceeds the temperature limit.

9. The LED lighting circuit according to claim 1, further comprising a duplicate of the LED arrangement and the bidirectional conduction arrangement connected with each other, and
the first detection outputs of the two bidirectional conduction arrangements are connected together and to the control circuit.

10. The LED lighting circuit according to claim 9, wherein the first detection outputs connected together are adapted to be superimpose the fault signals from the bidirectional conduction arrangements, and the control circuit is adapted to control the power supply arrangement to decrease the output power according to the superimposed fault signals.

11. A LED luminaire comprising the LED lighting circuit according to claim 1.
